(19) United States
(12) Patent Application Publication
(10) Pub. No.: US 2012/0048044 A1
(43) Pub. Date: Mar. 1, 2012

(54) MULTISTAGE AUTOMATIC TRANSMISSION

(75) Inventor: Kyung Yul Hyun, Seoul (KR)

(73) Assignee: UT GLOBAL CO., LTD., Daejeon (KR)

(21) Appl. No.: 13/148,039

(22) PCT Filed: May 17, 2010
(86) PCT No.: PCT/KR2010/003110

§ 371 Date: Aug. 4, 2011

(30) Foreign Application Priority Data
May 19, 2009 (KR) 10-2009-0043516
Jun. 29, 2009 (KR) 10-2009-0058199

(51) Int. Cl. F16H 3/087; F16H 3/42

(52) U.S. Cl. 74/337.5

(57) ABSTRACT

The present invention relates to a multistage automatic transmission comprising: a main body housing; an input shaft which is rotatably arranged in the main body housing and which rotates by an engine torque; a plurality of input side driving gears which have steps along the axial line of the input shaft and which are arranged into a pyramid shape to rotate together with the input shaft; a plurality of output side slave gears which have steps to correspond to the respective input side driving gears in directions opposite from one another; which engage with the respective input side driving gears, which are arranged into a pyramid shape, and the interior of which have a cam space; an output shaft arranged in the plurality of output side slave gears to receive power from the input shaft; and a shift control unit which is arranged in the cam space to selectively interconnect the output haft and the output side slave gear which receives power from any one of the plurality of input side driving gears, and to control gear shift by hydraulic pressure.

### TECHNICAL FIELD

The present invention relates to a multistage automatic transmission, and in particular to a new type multistage automatic transmission which makes it possible to obtain a forward eight times speed and higher or lower speed change stages, and the operations between the speed change stages are performed on the basis of an organic mechanism, thus enhancing a driving force transfer efficiency and a transmission feeling while improving a driving force performance as well as saving fuel consumption.

### BACKGROUND ART

The multistage automatic transmission applied to a vehicle or an industrial machine or something generally is formed of a plurality of satellite gear sets.

The gear train formed of a plurality of satellite gear sets serves to convert an engine torque into multiple stage torques when it is inputted as a rotational driving force from a torque converter and transmits to an output side.

The more the speed change stages are provided, the more advantageous the power train of the automatic transmission is in terms of their driving force performance and fuel consumption rate. Lots of researches are being conducted on developing a new train serving more speed change stages.

Even when the same speed change stages are implemented, since the durability, driving force transfer efficiency, and size and weight change a lot depending on a combining way of the satellite gear set, it is needed to develop a new gear train serving to minimize the loss in driving force and in compact size.

The development trend of the satellite gear set is focused on how to combine a conventional single pinion satellite gear set and a double pinion satellite gear set and where to arrange clutches and brakes, and how many one direction clutch are arranged at which position, thus implementing a transmission performance along with a desired speed change stage without loss in a driving force and a transmission ratio.

Meanwhile in case of the manual transmission, when there are too many speed change stages, it is needed for a driver to change transmissions more, which causes inconveniences.

In case of the automatic transmission, a computer transmission control unit (CJU) serves to automatically control the operations of the gear train depending on a driving state, so it is considered very valuable to develop a gear train serving more speed change stages.

Various researches are under development on the basis of above demands. A gear train with an automatic speed change stage with a forward 6-times speed and a forward 8-times sped is proposed.

The applicant of the present invention has proposed a new type multistage automatic transmission serving to easily perform a forward 8-times speed or more or fewer speed change stages and to enhance a driving force transmission efficiency and a transmission feeling with the aid of a good combination of an organic mechanism in the operation of speed change stages, while increasing a driving force performance and saving a fuel consumption.

### Disclosure of Invention

Accordingly it is an object of the present invention to provide a new type multistage automatic transmission which serves to easily implement a forward 8-times speed or more or less speed change stages and to enhance a driving force transmission efficiency and a transmission feeling with the aid of a good combination of an organic mechanism in the operation of speed change stages, while increasing a driving force performance and saving a fuel consumption.

It is another object of the present invention to provide a multistage automatic transmission which serves to easily implement a multistage transmission via a single pressure chamber and can be easily applied to a non-stage transmission, a stage-to-stage transmission, an automatic transmission and a manual transmission.

To achieve the above objects, there is provided a multistage automatic transmission, comprising a body housing; an input shaft which is rotatably provided at the body housing and rotates by means of an engine torque; a plurality of input side driving gears which each have steps along an axial line of the input shaft and are formed in a pyramid shape and rotate along with the input shaft; a plurality of output side driven gears which are formed in a pyramid shape having steps to be interconnected with the input side driving gears in the reverse direction and each have a cam space in their interiors; an output shaft which is provided at each output side driven gear and receives the driving force of the input shaft; and a speed change part which is provided in the cam space and selectively interconnects the output side driven gear, which receives a driving force from one among the input side driving gears by means of a hydraulic pressure, and the output shaft.

The output shaft comprises a shaft body which is arranged in a pyramid shape having steps to correspond one by one with the output side driven gears in a cam space of the output side driven gears; a pressure chamber which is formed in the interior of the shaft body and forms a plurality of divide flow paths passing through toward each output side driven gear; and a shaft bar which is connected with the shaft body and exposed t the outside of the body housing, and the speed change part, comprises a fluid supply part for supplying fluid to the pressure chamber for the fluid to be introduced into the divide flow path; a plurality of pistons which are provided at the divide flow paths of the pressure chamber and reciprocate toward the inner surface of the cam space depending on the pressure of the fluid introduced via the divide flow paths; a plurality of friction members which are connected with the pistons and operate by means of the pistons and selectively come into contact with the inner surface of the cam space and are pressurized; and a control part which controls the pressure of the fluid provided from the fluid supply part to the pressure chamber for the output shaft to rotate as one selected from the input side driving gears is connected with the output side driven gear corresponding to the selected input side driving gear and rotates along with the same.

There is further provided one direction clutch which is disposed between the input shaft and each input side driving gear and serves to make another input side driving gear rotate idle, said other input side driving gear rotating faster than the selected input side driving gear when one selected from the input side driving gears is engaged with the output side driven gear corresponding to the selected input side driving gear and rotates with the output side driven gear.

There is further provided a flow path rod which includes a plurality of flow paths communicating with the fluid supply part and the plurality of the divide flow paths for selectively supplying fluid through one divide flow path among the plurality of the divide flow paths; and a plurality of flow path guide grooves which are formed at the inlet and outlet portions of the flow paths along a circumferential direction on an outer surface, the flow path rod being connected with the output shaft for one region of the same to be inserted into the pressure chamber.

The reverse rotation intermediate gear is engaged to a gear which serves a backward movement among a plurality of input side driving gears.

A combination of the plurality of the input side driving gears and the plurality of the output side driven gears has one backward moment stage and eight forward movement speed change stages.

When one speed change stage selected from the forward movement eighth stage is undergone by means of hydraulic pressure provided from the hydraulic pump to the pressure chamber in accordance with a control signal of the control part, an input side driving gear and an output side driven gear of a high speed stage region higher than a corresponding speed change stage rotate in a slip friction state, and the input side driving gear and the output side driven gear of the corresponding speed change stage rotate in a stop friction stage, and an input side driving gear and an output side driven gear of a low speed stage region lower than the corresponding speed change stage rotate in a stop friction state, and other input side driving gears, which rotate in the stop friction state and rotate faster than the input side driving gear of the corresponding speed change stage by means of a difference in the circumferential speed between the input side driving gear and the output side driven gear, rotate idle by means of one direction clutch.

The backward movement stage forms a hydraulic flow path independent from the eight forward movement speed change stages.

A thrust bearing is disposed between the input side driving gears.

There is further provided a flow path rod housing which is engaged to an outer side of the body housing and surrounds and supports the exposed portions of the flow path rod exposed to the outside of the body housing.

A plurality of communication parts communicating with the flow path are formed at the surface of the flow path rod housing, with a nipple being engaged to each communication part.

There is further provided a plurality of solenoid valves which are provided at a hydraulic supply line extended from the hydraulic pump to the nipple and are turned on and off by means of the control part.

The flow path rod and said output shaft are ether integral types or separated types, and when the flow path rod and the output shaft are the separation types, the flow path rod and the output shaft are engaged by keys.

The plurality of the friction members are arranged at regular intervals along the circumferential direction in the interior of the cam space.

The plurality of the friction members are arc type blocks or balls.

The plurality of the pistons are provided corresponding to the plurality of the friction members one by one.

### Effects of the Invention

According to the present invention, there is provided a new type multistage automatic transmission which serves to easily implement a forward 8-times speed or more or less speed change stages and to enhance a driving force transmission efficiency and a transmission feeling with the aid of a good combination of an organic mechanism in the operation of speed change stages, while increasing a driving force performance and saving a fuel consumption.

In addition, the multistage automatic transmission serves to easily implement a multistage transmission via a single pressure chamber and can be easily applied to a non-stage transmission, a stage-to-stage transmission, an automatic transmission and a manual transmission.

### BRIEF DESCRIPTION OF THE DRAWINGS

The present invention will become better understood with reference to the accompanying drawings which are given only by way of illustration and thus are not limitative of the present invention, wherein;

FIG. 1 is a view of an inner structure of a multistage automatic transmission according to a first embodiment of the present invention;

FIG. 2 is a perspective view of an engaged state of an input side shaft and an input side gear of FIGS. 1;

FIG. 3 is a perspective view of an arrangement between an input side shaft/input side gear and an output side cam gear/output side shaft, showing a state except for a backward movement stage according to a first embodiment of the present invention;

FIG. 4 is a disassembled perspective view of an output side ca gear according to a first embodiment of the present invention;

FIG. 5 is a perspective view of an engaged state of a flow path rod and an output side shaft according to a first embodiment of the present invention;

FIG. 6 is a perspective view of a flow path rod housing according to a first embodiment of the present invention;

FIG. 7 is a cross sectional view of a structure of FIG. 6;

FIG. 8 is a front view of a flow path according to a first embodiment of the present invention;

FIG. 9 is a view of an arrangement state between an output side shat, an output side cam gear and an input side gear based on the operations of a friction member according to a first embodiment of the present invention;

FIG. 10 is a view of an inner structure of a multistage automatic transmission according to a second embodiment of the present invention;

FIG. 11 is a perspective view of an engaged state of an input side shaft and an input side driving gear of FIG. 1;

FIG. 12 is a perspective view of a state between an input side driving gear and an output side driven gear and shows except for a backward movement stage according to a second embodiment of the present invention;

FIG. 13 is a disassembled perspective view of an output side driven gear according to a second embodiment of the present invention;

FIG. 14 is a perspective view of an engaged state of a hydraulic supply pipe and an output side shaft according to a second embodiment of the present invention;

FIG. 15 is a view of an arrangement between an output side driven gear and an input side driving gear depending on the operations of a friction member according to a second embodiment of the present invention;

FIG. 16 is a view of an arrangement between an output side driven gear and an input side driving gear depending on the operations of a friction member in a multistage automatic transmission according to a third embodiment of the present invention;

FIG. 17 is a view of an arrangement between an output side driven gear and an input side riving gear depending on the operations of a friction member in a multistage automatic transmission according to a fourth embodiment of the present invention;

FIG. 18 is a view of an arrangement between an output side driven gear and an input side driving gear depending on the operations of a friction member in a multistage automatic transmission according to a fifth embodiment of the present invention; and

FIG. 19 is a view of an arrangement between an output side driven gear and an input side driving gear depending on the operations of a friction member in a multistage automatic transmission according to a sixth embodiment of the present invention.

### MODES FOR CARRYING OUT THE INVENTION

The preferred embodiments of the present invention will be described with reference to the accompanying drawings. The same constructions in the course of describing the embodiments will be given the same reference numerals. What the multistage automatic transmission is applied to a vehicle will be described as an example of the present invention.

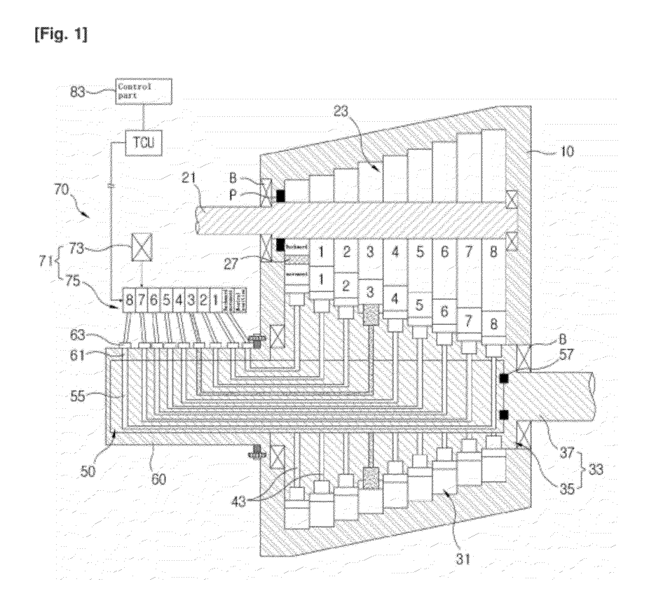

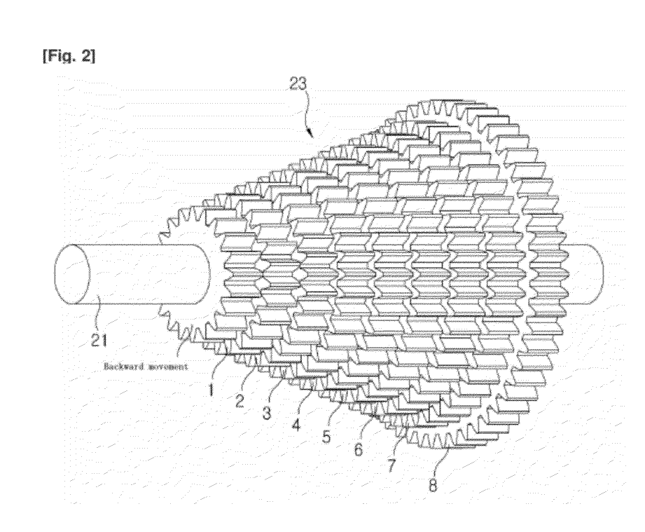

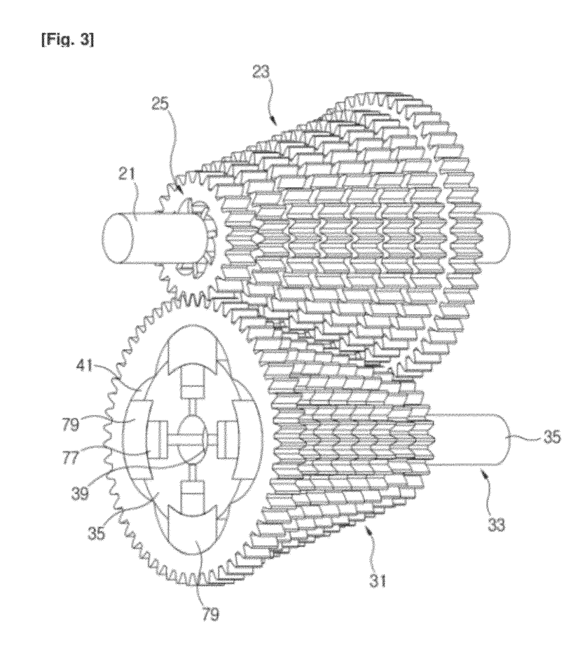

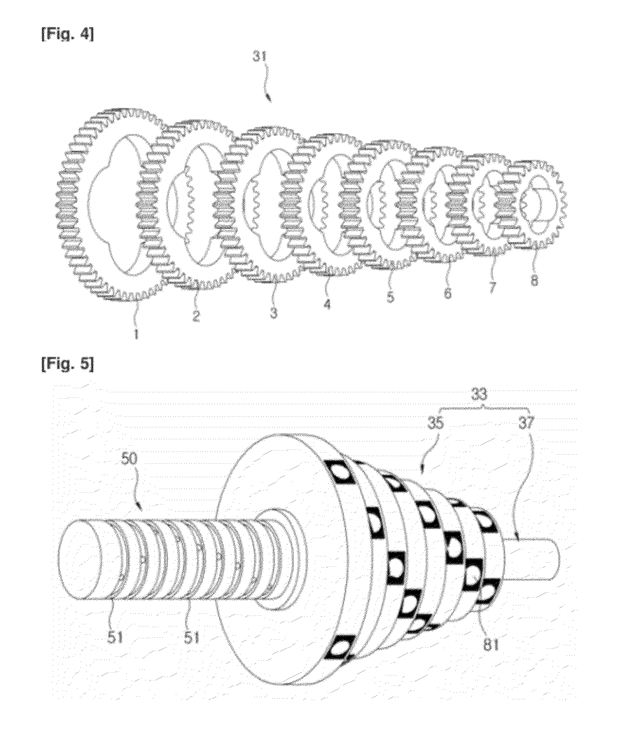

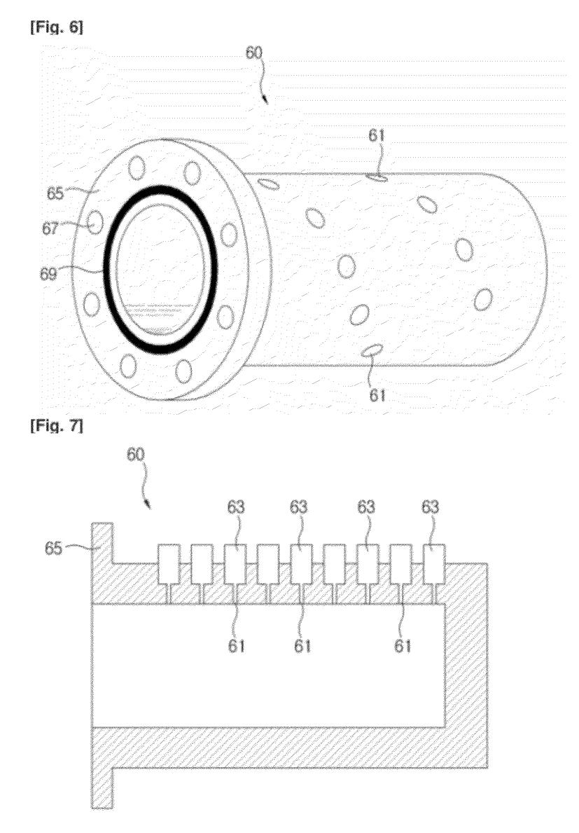

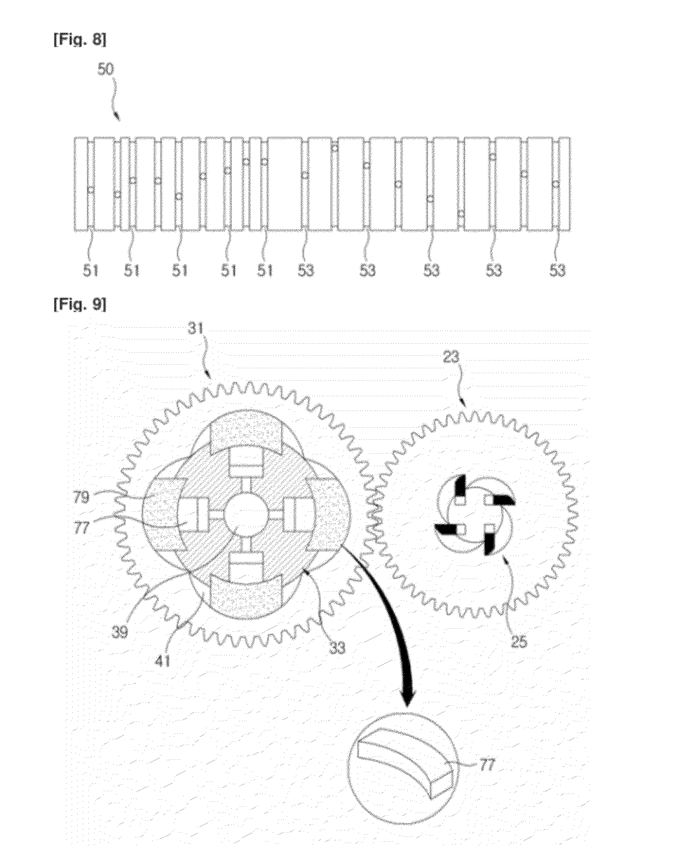

FIG. 1 is a view of an inner structure of a multistage automatic transmission according to a first embodiment of the present invention, FIG. 2 is a perspective view of an engaged state of an input side shaft and an input side gear of FIG. 1, FIG. 3 is a perspective view of an arrangement between an input side shaft/input side gear and an output side cam gear/output side shaft, showing a state except for a backward movement stage according to a first embodiment of the present invention, FIG. 4 is a disassembled perspective view of an output side ca gear according to a first embodiment of the present invention, FIG. 5 is a perspective view of an engaged state of a flow path rod and an output side shaft according to a first embodiment of the present invention, FIG. 6 is a perspective view of a flow path rod housing according to a first embodiment of the present invention, FIG. 7 is a cross sectional view of a structure of FIG. 6, FIG. 8 is a front view of a flow path according to a first embodiment of the present invention, and FIG. 9 is a view of an arrangement state between an output side shat, an output side cam gear and an input side gear based on the operations of a friction member according to a first embodiment of the present invention.

As shown in FIG. 1, the multistage automatic transmission according to the first embodiment of the present invention comprises a body housing 10, an input shaft 21 and a plurality of input side driving gears 23 as an input side construction, a plurality of output side driven gears 31 and an output shaft 33 as an output side construction, a flow path rod 50 connected with an output shaft 33 for a rotational force of the output shaft 33, and a transmission part 70 for selectively interconnecting the output side driven gear 31, which receives a driving force from one of the input side driving gears 23 and the output shaft 33, thus performing a transmission control.

First of all, the body housing 10 forms an outer construction of a multistage automatic transmission according to the present invention. The body housing 10 is made of a strong metallic material.

Almost of the elements are housed in the body housing 10 and are accommodated in the flow path rod housing 60, however, part of the input shaft 21 and the shaft bar 37 of the output shaft 33 are partially exposed to the outside of the body housing 10.

Bearings B are disposed between the input shaft 21 and the body housing 10, and the shaft bar 37 of the output shaft 33 and the body housing 10. A packing P is provided between them for sealing.

The input shaft 21 is a part rotating by engine torque. A driving force is inputted into the input shaft 21. The inputted driving force is increased or decreased via the output shaft 33 based on the structure which will be described later, and is outputted. The decreased and increase might include speed and torque.

The input side driving gear 23 is fixed at a radius outer side of the input shaft 21 in a pyramid shape and rotates along with the input shaft 21.

The multistage automatic transmission according to the present invention has one backward movement stage and eight forward movement speed change stages. The input side driving gear 23 of the pyramid type totally has nine stages. Since the input side driving gears 23 are provided in a form of nine-stage, the output side driven gear 31 and the shaft body 35 of the output shaft 33 are provided in a form of nine stages.

The above construction is provided as one example, but the multistage automatic transmission according to the present invention might have fewer or more than the forward rid speed change stages, in this case, the input side driving gear 23, the output side driven gear 31, and the shaft body 35 of the output shaft 33 are provided with proper numbers of stages.

For easier illustrations and descriptions, the reference numerals based on the positions of the input side driving gear 23 and the output side driven gear 31 are used in common, but characters and numbers are given on the drawings.

The input side driving gear 23 is engaged with the input shaft 21 by one direction clutch 25 (shown in FIGS. 3 and 9). The input side driving gear 23 might have an integral type input shaft 21 instead of using the one direction clutch 25.

When a vehicle runs freely, transmitting with the aid of the eight forward movement speed change stages, the rotation direction of the output shaft 33 is same except for the differences in the speed and torque. In case of the backward run, the output shaft 33 rotates in the opposite direction. So, a reverse rotation intermediate gear 27 is engaged at a gear (shown as character in the drawings) which serves the opposite direction movement among the input side driving gears 23.

The reverse rotation intermediate gear 27 is further provided between the input side driving gears 23 for reversing the rotation direction of the output side driven gear 31.

The output side driven gear 31, like the input side driving gear 23, is provided in the pyramid shape, but is arranged in the reverse form from the input side driving gear 23 and is tooth-engaged one by one in the reverse direction, and the inner space of the input side driving gear 23 is formed in a non-circular shape.

When the input shaft 21 connected with the input side driving gear 23 and the output shaft 33 with the shaft body 35 are formed in a multistage pyramid shape, the pressures of each speed change stage become same. When the parallel shaft is used, it is needed to form the pressures of each speed change stage differently.

When driving force is transmitted, the gear circle circumference ratio of each speed change stage is different. When the circle circumference ratio is different, the rotational force becomes different. When driving force is transmitted via the output shaft 33 and the output side driven gear 31, friction force also changes due to the difference in circle circumference ratio. In case of the parallel shaft, it is needed to provide a pressure differently depending on each speed change stage. Like the present embodiment, in case of the multistage output shaft 33, even when the circle circumference ratio of the output side driven gear 31 increases, the circle circumference ratio of the output shaft 33 increases in proportion thereto, so the friction force of the output shaft 33 and the output side driven gear 31 does not change. When the same pressure is applied to the entire speed change stages, the same friction force can be maintained.

The output shaft 33 is divided into the shaft body 35 and the shaft bar 37. The shaft body 35 and the shaft bar 37 might be made in an integrated form or might be separately made and then might be engaged.

The shaft body 35 is arranged in a pyramid shape while matching with the output side driven gear 31 in the interior of the output side driving gear 31 and remains separated between the output side driven gear 31 and the cam spaces 41 (shown in FIGS. 3 and 9). A pressure chamber 35 is formed in the shaft body 35, and the pressure chamber 35 forms a plurality of divide flow paths 43 connected toward a plurality of output side driven gears.

The shaft bar 37 is connected with the shaft body 35 and is exposed to the outside of the output side driven gear 31.

Since the output shaft 33 is separated from the output side driven gear 31, even when the output side driven gear 31 rotates, the output shaft 33 rotates idly in a slip friction state. When one of the shaft bodies 35 comes into contact with one of the output side driven ears 31 by the structure and operation, which will be described later, and is pressurized, thus forming one body, the output shaft 33 might rotate.

For the above operations, in other words, there are provided a flow path rod 50 and a transmission part 70 so that one of the shaft body 35 comes in contact with one of the output side driven gears 31 and is pressurized and forms one body.

The flow path rod 50 is configured with its one end being connected with the pressure chamber 39 of the shaft body 35 of the output shaft 33 and its remaining regions being formed in a rod shape exposed to the outside of the body housing 10.

The flow path rod 50 is engaged with the output shaft 33. In the present embodiment, the flow path rod 50 is made separated from the output shaft 33, and then keys 57 are engaged. Since it does not need to limit the scope of the claims, the flow path rod 50 and the output shaft 33 might be integral.

As shown in FIG. 8, a plurality of flow path rod guide grooves 51 and 53 are formed on the outer surface of the flow path rod 50 along its circumference. In the present invention, the flow path guide grooves 51 and 53 might be divided into nine first flow path guide grooves 51 positioned at the flow path rod housing 60 and nine second flow path guide grooves 53 disposed at the shaft body 35.

The first and second flow path guide grooves 51 and 53 are interconnected by means of a plurality of flow paths 55 in the interior of the flow path rod 50. The second flow path guide groove 53 communicates with the pressure chamber 39 formed in the shaft body 35 of the output shaft 33.

The region exposed from the flow path rod 50 to the body housing 10 is surrounded and supported by the flow path rod housing 60. The flow path rod housing 60 is tightly contacted with the body housing 10 and is engaged by means of a bolt.

As shown in FIGS. 6 and 7, a plurality of communication parts 61 are formed on the surface of the flow path rod housing 60, while communicating with the flow path 55, namely, communicating with the flow path 55 after communicating with the first flow path guide groove 51. A nipple 63 is engaged to the plurality of the communication parts 61, respectively.

Since the first flow path guide groove 51 is formed on the outer surface of the flow path rod 50 along the circumference, even when the flow path rod 50 rotates along with the output shaft 33, the operation oil can be supplied from the nipple 63 by means of the first flow path guide groove 51.

A flange 65 is disposed at one side of the flow path rod housing 60, and a bolt hole 67 is formed at the flange 65 for a bolt engagement with the body housing 10. An O-ring 69 is disposed at the inner side of the flange 65 contacting with the body housing 10.

The transmission part 70 comprises a fluid supply part 71 for supplying fluid to the pressure chamber 39 so that fluid is supplied to the divide flow path 43 of the pressure chamber 39, a plurality of pistons 77 provided at the divide flow paths 43, respectively, for reciprocating toward the inner surface of the cam space 41 depending on the pressure of fluid, a plurality of friction members 79 connected with the pistons 77 and operating by the pistons 77 and being selectively contacted and pressed by the inner surface of the cam space 41, and a control part 83 for controlling the pressure of the fluid provide from the fluid supply part 71 to the pressure chamber 39 so that the output shaft 33 can rotate as one selected from the input side driving gears 23 is engaged with the output side driven gear 31 corresponding to the input side driving gear 23.

The fluid supply part 71 comprises a hydraulic pump 73 for supplying fluid, and a plurality of solenoid valves 75 which are turned on or off by means of the control part 83. In this embodiment, nine solenoid valves 75 are provided.

The pistons 77 are engaged to the shaft body 35 of the output shaft 33, namely, are provided at regular intervals in the circumferential direction at each stage of the shaft body 35 provided in the nine-stage pyramid structure.

As shown in FIG. 9, the pistons 77 are reciprocate-engaged to the shaft body 35, and when hydraulic pressure is inputted into the pressure chamber 39 formed at an end of the shaft body 35 of the output shaft 33, it operates in an outward radius direction and serves to pressure the friction members 79 connected with the pistons 77 in the outer radius direction. When pressure is eliminated, the piston 77 and the friction member 79 restore their initial positions.

As described earlier, the plurality of the friction members 79 are connected with the pistons 77 and move in the outer radius directions based on the operations of the piston 77 and come into contact with the inner side of the output side driven gear 31 and are spaced apart. The friction member 79 is provided matching with the piston 77.

In the present embodiment, the friction member 79 has an arc shaped block structure and can input and output from the friction member groove 81 (FIG. 5) formed at the shaft body 35 of the output shaft 33. Four friction members 79 of the present invention are provided at intervals in the circumferential direction.

The friction member 79 serves to closely contact one of the shaft bodies 35 provided in the nine-stage pyramid structure to one of the output side driven gear 31.

As shown in FIG. 1, when hydraulic pressure is supplied to the position number 3, the pistons 77 of the position number 3 operate toward the outer side in the radius direction, and the friction members 79 of the position number 3 come into contact with the inner surface of the output side driven gear 31 of the position number 3, and the output side driven gear 31 and the output shaft 33 become integral and move forward as the output shaft 33 can be rotatable. At this time, the remaining rotates idle.

The control part 83 is connected with the output shaft 33 selected from the input side driving gears 23, and controls the supply path of the hydraulic pressure supplied from the hydraulic pump 91 to the flow path rod 50, thus rotating the output shaft 33.

The control part 83 serves to control the supply of hydraulic pressure supplied to the flow path 55 corresponding to the friction member 79 from the hydraulic pump 91 by closely contacting the friction member 79 of the output side driven gear 31 with one selected from the input side driving gears 23, so that the rotational force of the input side driving gear 23 can be transmitted to the output shaft 33.

The control part controls the transmission to be determined by the difference of the rotation between the output side and the input side. The control part continuously controls the transmissions to be performed to the low seed stage when there is a lot of difference between the computed value and the set value after the input side revolutions and the output side revolutions are computed by the input signal pulse generator sensor (not shown) transmitting the signals to the TCU (Transmission Control Unit) by detecting the revolutions and the output side pulse generator sensor (not shown).

In more details, the control part senses the revolutions of the input side and the output side by using a pulse generator and transmits the sensed information to the CJU (Computer Transmission Control Unit), and the computer computes and determines transmission. The solenoid valve 75 operates in accordance with the CJU signal, thus obtaining the optimum transmission. In case of the manual mode, the transmission is performed by manually operating the selection lever.

The operations and transmission sequences of the present invention when the multistage automatic transmission is applied to a vehicle will be described.

First of all, the operation will be described. When pressure is applied to the speed change stage in accordance with a TCU signal, the piston 77 pushes the friction member 79 with the aid of pressure, and the friction member 79 comes into close contact with the inner surface of the output side driven gear 31 and becomes engaged, thus allowing the vehicle to movement by means of the rotational force of the output shaft 33.

For example, a shown in FIG. 1, when hydraulic pressure is applied to the position number 3, and the piston 77 orates in the outer radius direction, the friction members 79 of the position number 3 come into contact with the inner surface of the output side driven gear 31 of the position number 3, and the output side driven gear 31 and the output shaft 33 of the position number 3 become one body, so the output shaft 33 rotates, and the vehicle runs forward.

At this time, the remaining speed change stages have zero pressures, and there is no pushing pressure from the piston 77, the operation becomes neutral state, so it rotates idle without any load. When the pressures of the entire speed change stages are zero, the neutral state remain.

The transmission operation will be described. For reference, in case of the automatic transmission, pressure is applied by means of a TCU signal, and in case of the manual transmission, pressure is applied to the speed change stage based on the selection lever, and the remaining speed change stages perform transmissions by the on and off operations of the solenoid valve 75.

In the present embodiment, the pressure is set at each speed change stage with respect to the maximum pulling force of the slip friction rotation driving wheels which operate like the torque converter of the automatic transmission, and when the pulling force of above the set pressure decreases, the slip friction rotation occurs at the stop friction.

For example, when D is selected at the selection lever at the time of getting started, the one stage load is applied, and the vehicle runs forwards, and the brake is applied during the forward run, the output side stops, and the input side keeps rotating. In other words, the rotation of the output shaft 33 stops, and the output side driven gear 31 separated from the output shat 33 rotates with slip friction. The friction member 79 partially inserted into the output shaft 33 has a slip friction over the protrusion of the output side driven gear 31 and then stops, but the output side driven gear 31 keeps rotating.

Consequently, when D is selected at the automatic transmission selection lever, the load is applied to the input side and the output side by means of the torque converter, so the vehicle keeps running forwards, and when the brake is applied while forwardly moving, the output side stops, and the input side slip-rotates.

Even when the output side stops, but the rotational force serving to move forwards keeps at the input side. In terms of the slip friction rotation, the output side stops like the torque slip mode, but the rotational force that the output side tends to move forward is maintained.

When the brake is released, the forward movement of the output side is performed. The stop friction rotational force and the slip friction rotational force operate like the torque converter of the automatic transmission.

In case of the manual transmission, when brake is applied in a state that the clutch remains in the stop friction state, the engine stops. In case of the automatic transmission, the engine does not stop by the slip of the torque converter when the brake is applied in a load applied state, namely, the engine normally operates. In the present invention, when the brake is applied in a state with the load being applied, the engine does not stop, namely, normally operates based on the slip friction rotation.

When the pulling force at the output side decreases, the slip friction rotation occurs, and when the pulling force is restored, the stop friction rotation occurs. When the pulling force decreases, the torque converter slips, and the present invention has a slip friction.

The control part controls the determination of the transmission based on the difference in the revolutions between the output side and the input side. The control part continuously controls the transmissions to be performed to the low seed stage when there is a lot of difference between the computed value and the set value after the input side revolutions and the output side revolutions are computed by the input signal pulse generator sensor (not shown) transmitting the signals to the TCU (Transmission Control Unit) by detecting the revolutions and the output side pulse generator sensor (not shown). In this case, the differences in the revolutions between the input side and the output side occur since the output side has a slip rotation, and the slip rotation causes the decrease in the pulling force of the output side.

If there is no difference in the revolutions between the input side and the output side, a higher speed change stage is obtained. When the slip rotation continuously occurs in the curse of the conversion into a high stage without any difference in revolutions, the stage is switched to the low stage. When there is a difference in the revolutions between the input side transmission ration and the output side transmission ratio rather than the set revolutions, the stage is changed to the low speed stage, and when there is no difference for the set revolutions, the speed stage is continuously switched to the higher stages with a certain time difference.

When there is no revolution difference at the highest stage, the transmission does not occur, and when there is a revolution difference, the stage is transmitted to the low speed stage. In the lowest speed change stage, even when there is a revolution difference, the transmission does not occur, and only when there is not a revolution difference, the transmission to the higher stage is performed.

According to the embodiments of the present invention, it is possible to easily perform the forward movement eight-times transmission or higher or lower speed change stages, and the operations between the speed change stages are performed depending on the organic mechanism, thus enhancing the driving force transfer efficiency and transmission feeling. The driving performance can be enhanced, and the fuel consumption can be saved.

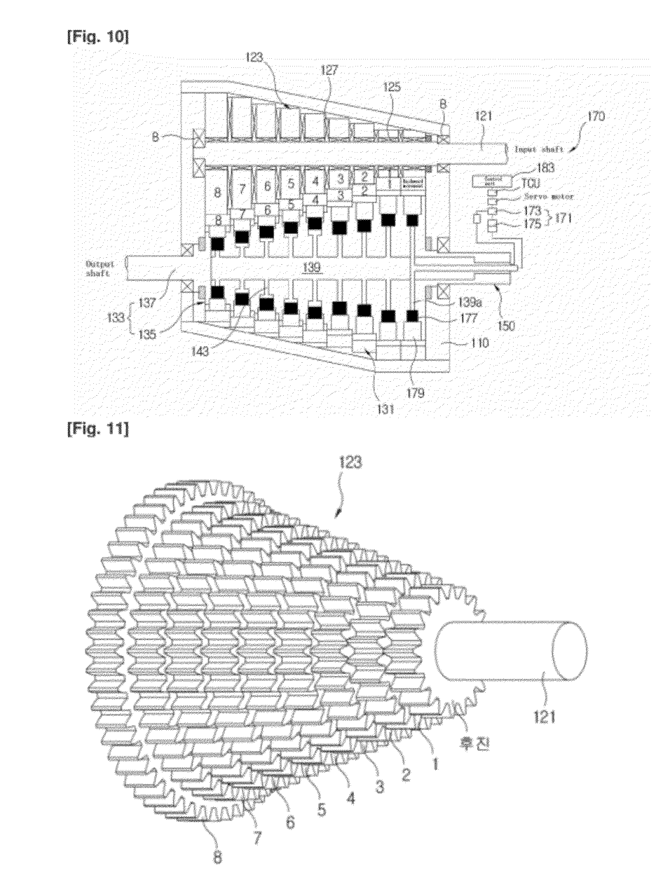

FIG. 10 is a view of an inner structure of a multistage automatic transmission according to a second embodiment of the present invention,

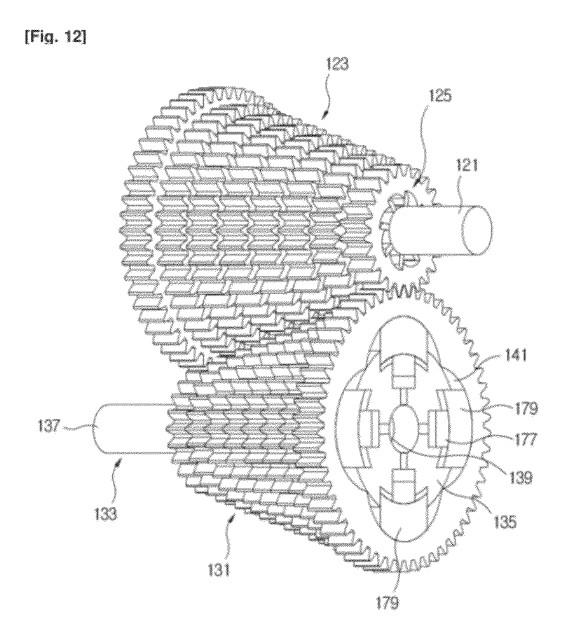

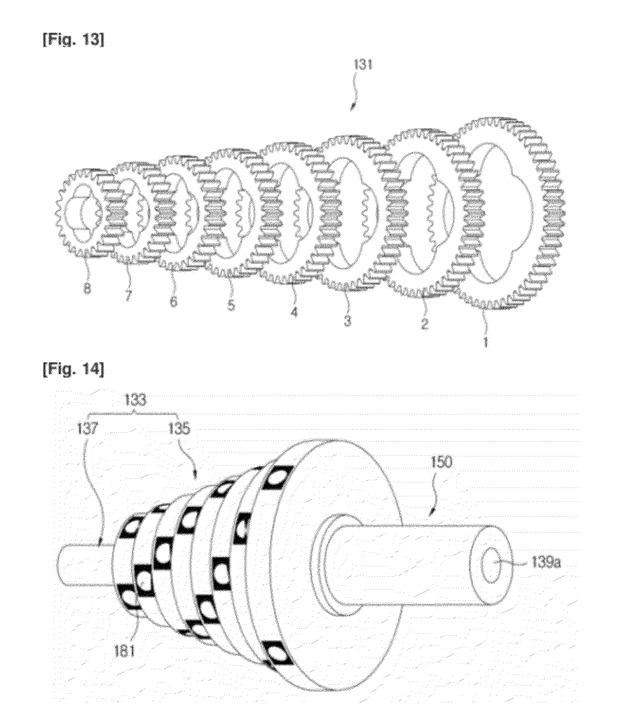

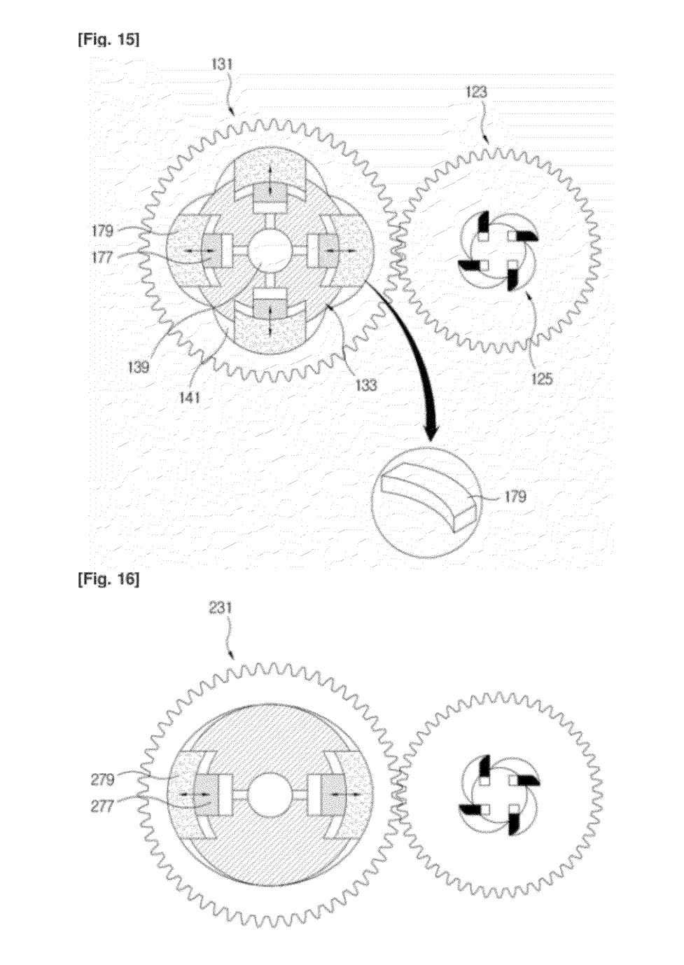

FIG. 11 is a perspective view of an engaged state of an input side shaft and an input side driving gear of FIG. 1, FIG. 12 is a perspective view of a state between an input side driving gear and an output side driven gear and shows except for a backward movement stage according to a second embodiment of the present invention, FIG. 13 is a disassembled perspective view of an output side driven gear according to a second embodiment of the present invention, FIG. 14 is a perspective view of an engaged state of a hydraulic supply pipe and an output side shaft according to a second embodiment of the present invention, and FIG. 15 is a view of an arrangement between an output side driven gear and an input side driving gear depending on the operations of a friction member according to a second embodiment of the present invention.

The multistage automatic transmission according to a second embodiment of the present invention comprises a body housing 110, an input shaft 121 and an input side driving gear 123 as an input side construction, an output side driven gear 131 and an output shaft 133 as an output side construction, a hydraulic supply pipe 150 connected with the output shaft 133, and a transmission part 170 selectively connecting the output side driven gear 131, which receives a driving force from one of the input side driving gears 123, and an output shaft 133, thus transmission-controlling the same.

The body housing 110 forms an outer construction of the multistage automatic transmission according to the present invention. The body housing 110 is made of a strong metal material. Most of the constructions are accommodated in the body housing 110.

A region of the input shaft 121 and the shaft bar 137 of the output shaft 133 are partially exposed to the outside of the body housing 110.

Bearings B are disposed between the input shaft 121 and the body housing 110 and between the shaft bar 137 of the output shaft 133 and the body housing 110 for smooth rotations, and a packing (not shown) is also disposed between the same for sealing.

The input shaft 121 rotates by an engine torque, namely, a driving force for driving the input shaft 121 is inputted into the same.

The input side driving gear 123 is fixed at the outer radius portion of the input shaft 121 in a pyramid shape and rotates along with the input shaft 121.

The input side driving gear 123 is engaged with the input shaft 121 by means of one direction clutch 125 (FIGS. 10 and 15) for a rotation along with the input shaft 121. A thrust bearing 127 is disposed between the input side driving gears 123.

For easier illustrations and descriptions, the reference numerals based on the positions of the input side driving gear 123 and the output side driven gear 131 are given same, showing on the drawings.

The output side driven gear 131 is formed in a pyramid shape like the input side driving gear 123, but is arranged in the reversed arrangement from the input side driving gear 123, and is tooth-engaged with the input side driving gear 123 one by one in the reversed direction. The inner space of the output side driven gear 131 is formed in a non-circular shape.

The output shaft 133 is divided into a shaft body 135 and a shaft bar 137. The shaft body 135 and the shaft bar 137 might be integral or might separately manufactured, and then might be engaged with each other.

The shaft body 125 is arranged in a pyramid shape while matching with the output side driven gear 131 one by one in the interior of the output side driven gear 131 and is separated about the output side driven gear 131 and the cam space 141 (FIG. 12). Here, a single pressure chamber 139 is formed in the shaft body 135.

The shaft bar 137 is connected with the shaft body 135 and exposed to the outside side driven gear 131.

Since the output shaft 133 is separated from the output side driven gear 131, even when the output side driven gear 131 rotates, the output shaft 133 slips and rotates idle. One of the shaft bodies 135 comes into contact with one of the output side driven gears 131 and is pressurized, thus becoming one body, so that the output shaft 133 can rotate.

For the above operations, in other words, there are provided a hydraulic supply pipe 150 and a transmission part 170 so that one of the shaft bodies 135 comes into contact with one of the output side driven gear 131 and is pressurized, thus forming one body.

The transmission part 170 comprises a fluid supply part 171 for supplying fluid to the pressure chamber 139 so that fluid is supplied to the divide flow path 143 of the pressure chamber 139, a plurality of pistons 177 provided at the divide flow paths 143, respectively, for reciprocating toward the inner surface of the cam space 141 depending on the pressure of fluid, a plurality of friction members 179 connected with the pistons 177 and operating by the pistons 177 and being selectively contacted and pressed by the inner surface of the cam space 141, and a control part 183 for controlling the pressure of the fluid provide from the fluid supply part 171 to the pressure chamber 139 so that the output shaft 133 can rotate as one selected from the input side driving gears 123 is engaged with the output side driven gear 131 corresponding to the input side driving gear 123.

The fluid supply part 171 comprises a hydraulic pump 173 for supplying fluid, and a plurality of solenoid valves 175 which are turned on or off by means of the control part 183.

The plurality of the pistons 177 are provided at the plurality of the divide flow paths 143 divided toward the output side driven gear 131 from a single pressure chamber 139, thus moving inwardly or outwardly based on the pressure supplied.

The pistons 177 are engaged to the shaft body 135 of the output shaft 133, namely, are provided at regular intervals in the circumferential direction at each stage of the shaft body 135 provided in the nine-stage pyramid structure.

As shown in FIG. 15, the pistons 177 operate in the outward direction of the radius direction when hydraulic pressure is inputted into the pressure chamber 139 formed at the portion of the shaft body 135 of the output shaft 133 while allowing the friction members 179 connected to the piston 177 to be pressurized in the outer direction of the radius direction. When the pressure is removed, the piston 177 and the friction member 179 restore their initial positions.

The plurality of the friction members 179 are connected with the pistons 177 and move in the outer direction of the radius direction based on the operation of the piston 177, and the friction member 179 might be provided matching with the piston 177 one by one.

In the present invention, the friction member 179 has an arc shaped block structure and is accommodated in the friction member groove 181 (FIG. 14) formed at the shaft body 135 of the output shaft 133. In the present embodiment of the present invention, four friction members 179 are provided at regular intervals along the circumferential direction.

The friction member 179 serves to one selected from the shaft bodies 135 provided in the nine-stage pyramid structure with one among the plurality of the output side driven gears 131.

The control part 183 serves to control the hydraulic pressure supplied from the hydraulic pump 91 to the pressure chamber 139 for the output shaft 133 to rotate by means of a pair of the gears selected from the input side driving gears 123 and the output side driven gears 131.

In other words, when one speed change stage becomes operational among the forward movement eight stages by means of the hydraulic pressure provided from the hydraulic pump 91 to the pressure chamber 139 based on a control signal from the control part 183, the input side driving gear 123 and the output side driven gear 131 of the high seed stage region higher than a corresponding speed change stage slip and friction-rotate, so the input side driving gear 123 and the output side driven gear 131 of a corresponding speed change stage stop-friction rotate, and the input side driving gear 123 and the output side driven gear 131 of the low speed stage region lower than a corresponding speed change stage stop-friction rotate, and the other input side driving gear 123 faster rotating than the input side driving gear 123 of a corresponding speed change stage by means of the difference in the circumferential speed between the input side driving gear 123 and the output side driven gear 131 rotate idle by means of the one direction clutch 125.

The one direction clutch 125 is disposed between the input shaft 121 and each input side driving gear 123, and when one of the input side driving gears 123 and the output side driven gear 131 corresponding to the selected input side driving gear 123 are engaged with each other and rotate, the one direction clutch serves to rotate idle the other input side driving gear 123 faster rotating than the selected input side driving gear 123.

When the output side driven gear 131 corresponding to the selected input side driving gear 123 is engaged and rotates, the other input side driving gear 123 having a diameter smaller than the selected input side driving gear 123 rotates faster than the selected input side driving gear 123 due to the difference in the number of teeth between the output side driven gears 131. So, the output side driven gear 131 corresponding to the other input shaft driving gear 123 does not rotate.

In the multistage automatic transmission according to the present embodiment, when the input shaft 121 is driven, the input side driving gear 123 and the output side driven gear 131 are engaged and rotate. The inner surface of the input shaft 121 is formed of one direction clutch 125, and the outer surface of the output side driven gear 131 is formed of gears, and the inner surface of the same is formed of cam or eccentric ring gear.

The pressure chamber 139 is formed at the inner surface of the output shaft 133 of the output side multistage shape, and when the piston 177 retracts by means of the hydraulic pressure, the friction member 179 comes into close contact with the inner surface space of the output side driven gear 131, which is the cam gear, so the driving force is applied t the output side driven gear 131 by means of the input side driving gear 123.

The neutral state during the transmission will be described. When the pressure of the pressure chamber 139 is made zero, namely, when hydraulic pressure is not supplied, since there is not any pressure pushing the piston 177, the friction member inserted in the load output shaft 133 slip-friction rotates against the protrusion (not shown) of the cam ring without any load, so it rotates idle. The input side driving gear 123 and the output side driven gear 131 are engaged with each other and rotate, and the output shaft 133 becomes neutralized state, not rotating, by the slip rotation of the friction member 179 and the output side driven gear 131.

As shown in FIG. 10, the backward movement will be described. In case of the backward run, there is provided a pressure chamber 139a as compared with the forward movement eight times speed, pressure is applied only to the backward movement pressure chamber 139a, as a result of which the vehicle runs backwards. The backward movement gear (not shown) is engaged with the driven gear 131, the intermediate gear and the driving gear 123. According to another embodiment of the present invention, the driving gear 123 and the driven gear 131 can be interconnected with a chain, so a reverse rotation is possible. At this time, the pressure is zero for the forward movement one to eight times stage, so a slip idle rotation is maintained without any load, and the stop friction rotation is kept only in case of the backward run, so the driving force is supplied. Consequently, the transmission according to the present invention is formed of one forward movement pressure chamber 139 and a backward movement pressure chamber 139a.

Meanwhile the stop friction rotation and the slip friction rotation will be described. The piston 177 reciprocates upwards and downward in the pressure chamber 139 at the inner surface of the output shaft 133 by means of the pressure, and the friction member 179 is engaged or disengaged at the cam space 141, thus performing the stop friction rotation or the slip friction rotation.

The inner surface of the outer side driven gear 131 is formed in a cam shape and is formed of a protrusion of the cam and a space, so the stop friction rotation or the slip friction rotation are performed.

When the pressure is above the set pressure level, the piston 177 does not travel over the protrusion of the cam and stop-friction rotates, and when the pressure is below the set pressure, the piston retracts, so the piston 177 travels over the protrusion of the cam, and slip-friction rotates. When the piston does not travel over the protrusion, and then stop-friction rotates, the output shaft 133 rotates, and when the piston travels over the protrusion and then slip-friction rotates, the rotation speed of the output shaft 133 decreases or the output shaft 133 stops rotating. Since the output shaft 133 and the output side driven gear 131 are separated, the stop friction is related with an engaged state, and the slip friction is related with a separated state.

The operations of the transmissions will be described based on the above constructions.

First of all, the first-stage transmission will be described. When a weak pressure is given to the first stage, the first stage becomes a stop friction, and the first stage part rotates. At this time, the backward movement slips in an idle rotation since the pressure is zero, and the input side driving gear 123 is engaged with the output side driven gear 131 in a range of 1-8 stages and rotates, and the output side driven gear 131 rotates a stop friction in case of only one stage, and the 2-8 stages remain a load slip friction rotation state.

The four-stage transmission will be described. When the intermediate pressure (corresponding to the fourth stage) is given, the load is applied to the fourth stage, so the fourth stage transmission is performed. The first to third stages of the input side driving gear 123 rotate idle by means of the one direction clutch 125, and the fourth to eighth stage part rotate in a load state along with the output side driven gear 131. At this time, the first to fourth stages of the output side driven gear 131 rotate in the stop friction state, and the fifth to eighth stage part rotate in the load slip state.

The eighth speed change stage will be described. When the highest pressure level (corresponding to the eighth stage) is applied, the eighth speed change stage is performed. At this time, the first to seventh stages of the input side driving gear 123 rotate idle by means of the one direction clutch 230, and only the eighth stage is load-rotated, thus transferring driving force. The first to eighth stages of the output side driven gear 131 rotate in the stop friction state, but the first to seventh stages of the input side driving gear 123 rotate idle by means of the one direction clutch 125, so the first to seventh stages of the output side driven gear 131 rotate idle. When the pressure is high, the movement transmission is performed at the high speed stage, and when the pressure is lower, the movement transmission is performed at the lower speed stage.

The speed change procedure will be described in more details. Assuming that the maximum force is 100, the driving force transfer will be described.

First of all, the first stage speed change will be described. The pulling force of 100 is divided by eighth speed change stages, thus obtaining 12.5. Namely, the pressure of pushing the piston 177 to each stage becomes 12.5. When the pressure of 12.5 is given, the load is applied to only the first speed change stage, so the driving force is transferred, and rotation is obtained. The output side first speed change stage is given the load from the low speed stage point where the stop friction rotational force 12.5×7=87.5+12.5=100, namely, the sum of the rotational force becomes 100. The first to eighth speed change stages of the driving gear 123 rotate with load in engagement with the output side driven gear 131, and only the first speed change sage of the output side driven gear 131 rotates in the stop friction state, and the second to eighth stage part rotate in the slip friction state along with the output side driven gear 131.

Next, the second speed change stage will be described. When the pulling force of 100 is divided by 7 (in case of second stage, the first stage means an idle rotation, so it corresponds to the seventh stage except for the first stage), 14.3 is obtained. Namely, the pressure of pushing the piston 177 to each speed change stage is 14.3. When the pressure of 14.3 is given, the second speed change stage is performed. At this time, the first stage of the input side driving gear 123 rotates idle by means of the one direction clutch 125, and the second to eighth stage part rotate with load. The first to second stages of the output side driven gear 131 rotate in the stop friction state, and the third to eighth stage part rotate in the load slip friction state. At this time, the first stage of the speed change rotates idle by means of the input side driving gear 123.

The above principles can be applied to the third speed change stage and the fourth speed change stage as well.

Next, the fifth speed change stage will be described. When the pulling force of 100 is divided by 4, 25 is obtained. The pressure of pushing the piston 177 to each stage is 25. When the pressure of 25 is given, the fifth speed change stage is obtained. At this time, the first to fourth speed change stages of the input side driving gear 123 rotate idle, and the fifth to eighth stage part rotate with load, and the first to fifth stages of the output side driven gear 131 rotate in the stop friction state, and the sixth to eighth stage part rotate in a slip friction state.

Next, the eighth stage speed change will be described. When the pressure of 100 is given, the eighth speed change stage is obtained. The first to seventh speed change stages of the input side driving gear 123 rotate idle by means of the one direction clutch 125, and only the eighth speed change stage rotates. The first to eighth speed change stages of the output side driven gear 131 rotate in a stop friction state, and the first to seventh speed change stages rotate idle by means of the input side driving gear 123.

When it is needed to change to the sixth speed change stage in the course of the eighth stage, the pressure of 33.3 is provided, which corresponds to the sixth speed change stage. Since the seventh to eighth speed change stages of the output side driven gar 131 are lower than the set pressure, the slip friction rotation is obtained, and the first to sixth stages rotate in the stop friction state. At this time, the first to fifth stages have different circumferential speeds between the input side driving gear 123 and the output side driven gear 131, the input side diving gear 123 rotates faster due to the differences of the teeth between the input side driving gear 123 and the output side driven gear 131. The idle rotation is performed by means of the one direction clutch 125 provided at the input side. When the input side driving gear 123 rotates idle, the output side driven gear 131, which rotates in the stop friction state, rotates idle as well.

As another example, the pressure is set 16.6 and the vehicle runs on a flat road at the third stage. In this state, when the pressure of 50 which corresponds to the seventh stage is given, the seventh stage speed change is performed. When 50 corresponding to the eighth stage slip friction rotational force and 50 corresponding to the seventh stage rotational fore are summed, 100 is obtained. Consequently, the seventh stage rotational force becomes 100, and the speed change is obtained from the lower stage to the higher stage where the sum of the pressure becomes 100.

The operation of the multistage automatic transmission with the above construction will be described.

When the vehicle gets started, the input side driving gear 123 and the output side driven gear 131 are engaged with each other and start rotating. At this time, the output side driven gear 131 rotates in the slip friction state without ant load, namely, rotates idle. The output shaft 133 does not rotate.

When the vehicle gets started, the drive D mode is selected using the selection lever. Weak hydraulic pressure is applied to the cylinder of each stage, so the vehicle starts moving slowly in the forward direction. At this time, when a brake is applied, the whole speed change stages rotate in the load slip friction state. When the brake is removed, and the forward acceleration pedal is stepped on, the pressure gradually increases, so the non-stage speed changes are obtained without any disconnection on the way to higher stages.

The pressure is decreased in order to speed change to the low speed stage. When the pressure is continuously increased, the speed change to the higher speed stage is continuously performed. And when the pressure is continuously decreased, the speed change to the lower speed stage is continuously performed without any disconnection or stops.

All the operations including a startup mode, a climbing mode, an acceleration mode, a backward moment and a forward movement can be obtained by adjusting the revolutions of the hydraulic pump in accordance with a signals from TCU (Transmission Control Unit), and the pressure can be adjusted by means of the difference in capacities.

For example, when the speed stage is changed from the first stage to the second stage, the pressure corresponding to the second stage is gradually applied, thus obtaining the second speed change stage. When the pressure is applied without any gradual steps, the stages are removed during the speed change. Assuming that the first stage pressure is 100, and the second stage pressure is 120, when the pressure is given 110 between the first stage and the second stage during the speed change, the speed change is obtained between the first stage and the second stage. Even when there is not a speed change stage between the first stage and the second stage, the middle speed change ratio between the first stage and the second stage, namely, the first stage and half (½) speed change is obtained. When the pressure of 105 is applied, the first stage and ¼ speed change is obtained. When the pressure is applied without stages, the speed change is obtained without stages.

The load slip friction rotation force changes in proportion to the changes of the pressure. Each stage is given the same pressure, so the load is applied from the higher stage, and when the pressure is lower than the set pressure, the slip friction rotation is obtained, and then the speed change is continuously performed to the following stage, so the stop friction rotation is obtained at the stage corresponding to the set pressure. When the pressure increases more and more, the speed change is performed up to the highest stage, and there is not higher stage than the highest stage, the speed change stops at the highest stage. On the contrary, when the pressure decreases more and more, the speed change is performed down to the lowest stage and stops.

For reference, a belt type non-stage transmission is disclosed, but such belt type non-stage transmission has a limit in a tensional force of the belt, so it should be applied to a small size vehicle with less driving force, whereas the present invention is directed to the ways that the speed changes are performed on the basis of the differences in pressures, so the present invention can be well applied to all kinds of the vehicles irrespective of the driving force if pressure corresponding to the driving force can be supplied.

As described above, according to the present embodiment, the multistage speed change can be easily performed with the aid of the single pressure chamber 139, and the present invention can be well applied to a non-stage speed change, a step-by-step speed change, an automatic speed change and a manual speed change, and the driving force transfer efficiency and the speed change feeling are better than the conventional art, and the driving force performance can be enhanced while saving fuel consumption.

In the above previous embodiment descriptions of the present invention, the descriptions have been omitted, but the present invention can be well applied to a non-stage speed change, a step-by-step speed change, an automatic speed change and a manual speed change, etc.

The non-stage speed change is directed to changing a pressure via no stages, namely, without any steps, so the driving force keeps connected with the aid of the load slip friction rotation, thus obtaining a non-stage speed change.

The step-by-step speed change is directed to applying the pressure to the speed change stages step-by-step in a way that the first stage is given the pressure of 12.5, the third stage is given the pressure of 16.7, and the sixth stage is given the pressure of 33.3, and the eighth stage is given the pressure of 100.

The automatic speed change can be implemented by operating the hydraulic pump or adjusting the revolution of the hydraulic pump in accordance with a signal from the TCU (Transmission Control Unit).

The manual speed change can be implemented as the inverter DC motor is operated by a selection lever.

At this time, the friction clutch of the manual transmission or the fluid torque converter of the automatic transmission are not needed. When the pressure is given to the pressure chamber of the output side driven gear 131, the first to eighth stages rotate in the slip friction state. Rotational force occurs at the output shaft by means of the slip friction rotation. At this time, the rotational force generated is the same as the rotational force of the torque converter, so it operates like the torque converter. When the pressure supply is turned on or off, the slip friction rotation occurs when the pressure is zero, and when the pressure is given, the stop friction rotation occurs operating like the operation of the clutch. All the operations such as a backward movement, a forward movement, a neutral operation and a clutch are performed by an operation pressure in accordance with a TCU signal or a selection lever signal. The discharge amount of the hydraulic pressure is adjusted by a DC motor rotation adjustment. When the revolution is higher, the pressure increases, and when the revolution is lower, the pressure decreases. When the revolution is higher, the discharge amount increases, so the pressure increased in the interior while passing through the orifice. When the revolution is lower, the discharge amount is small, and the amount of the flow via the orifice is small, so the pressure decreases in the interior.

In the previous embodiments of the present invention, the pressure chamber 139 has been installed at the output side, but it can be installed at the input side, which results in the same effects.

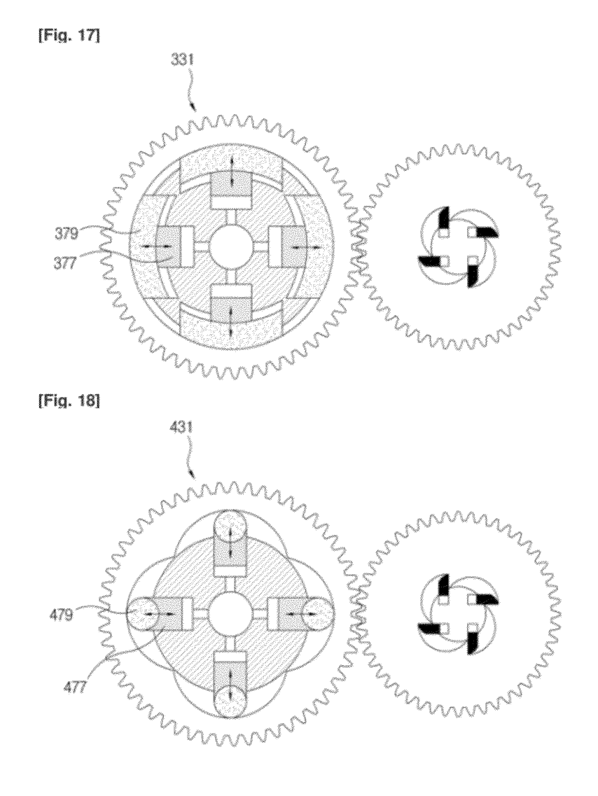

FIGS. 16 to 19 are views of the arrangements of the output side driven gear and the input side driving gear depending on the operations of the friction member in the multistage automatic transmission according to the third to sixth embodiment of the present invention.

As shown in FIG. 16, differently from the first and second embodiment of the present invention, two pistons 277 and two friction members 279 are provided along the circumferential direction. In this case, the inner space structures of the output side driven gear 231 and the inner space structure are a little different, but the remaining constructions are same as the first and second embodiment of the present invention.

As shown in FIG. 17, four pistons 377 and fourth friction members 379 are provided along the circumferential direction, which are the same as the first and second embodiments, but the inner space structure of the output side driven gear 331 is circular, which is different from the first and second embodiments of the present invention. Even when the structure of FIG. 17 is applied, the same effects can be obtained in the present invention.

As shown in FIG. 18, the shape of the friction member 479 is not an arc shaped block structure but a ball structure. In this case, the inner space structure of the output side driven gear 431 is a little different, but the remaining constructions and operations are same as the first and second embodiments of the present invention.

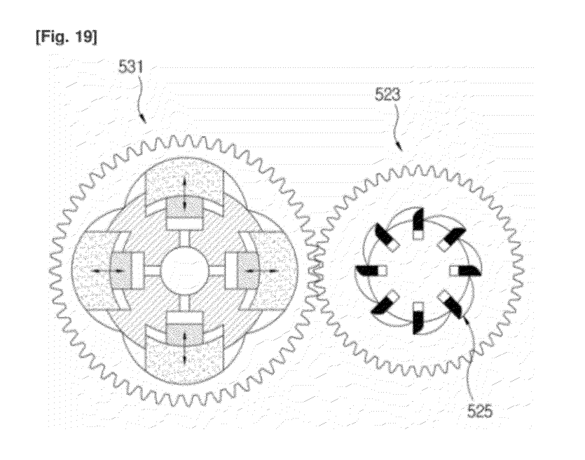

As shown in FIG. 19, the construction of the output side driven gear 531 is same as the first and second embodiments of the present invention, provided that in case of the embodiment of FIG. 19, the one direction clutch 525 in the input side driving gear 523 is different from the previous embodiment of the present invention.

Meanwhile, in the previous embodiments of the present invention, it has been described that the flow path rod is connected to the output shaft, and the piston and the friction members are provided at the output shaft, and a corresponding friction member of the output side driven gear comes into close contact with one selected from the input side driving gears, thus transferring the rotational force of the selected input side driving gear to the output shaft, but in another example, the flow path rod is connected to the input shaft, and the piston and the friction member are provided at the input shaft, and a corresponding friction member is made to come into close contact with the input side driven gear the inner space of which corresponding one selected from the output side gears is formed in a non-circular shape, thus transferring the rotational force of the selected input side driven gear to the output shaft.

In the previously embodiments of the present invention, the detailed descriptions have been omitted, but the multistage automatic transmission according to the embodiments of the present invention can be well applied to a common vehicle, a heavy equipment vehicle and various industrial vehicles.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A multistage automatic transmission, comprising:
a body housing;
an input shaft which is rotatably provided at the body housing and rotates by means of an engine torque;
a plurality of input side driving gears which each have steps along an axial line of the input shaft and are formed in a pyramid shape and rotate along with the input shaft;
a plurality of output side driven gears which are formed in a pyramid shape having steps to be interconnected with the input side driving gears in the reverse direction and each have a cam space in their interiors;
an output shaft which is provided at each output side driven gear and receives the driving force of the input shaft; and
a speed change part which is provided in the cam space and selectively interconnects the output side driven gear, which receives a driving force from one among the input side driving gears by means of a hydraulic pressure, and the output shaft.

2. The transmission of claim 1 wherein said output shaft comprises:
a shaft body which is arranged in a pyramid shape having steps to correspond one by one with the output side driven gears in a cam space of the output side driven gears;
a pressure chamber which is formed in the interior of the shaft body and forms a plurality of divide flow paths passing through toward each output side driven gear; and
a shaft bar which is connected with the shaft body and exposed t the outside of the body housing, and
said speed change part, comprising:
a fluid supply part for supplying fluid to the pressure chamber for the fluid to be introduced into the divide flow path;
a plurality of pistons which are provided at the divide flow paths of the pressure chamber and reciprocate toward the inner surface of the cam space depending on the pressure of the fluid introduced via the divide flow paths;
a plurality of friction members which are connected with the pistons and operate by means of the pistons and selectively come into contact with the inner surface of the cam space and are pressurized; and
a control part which controls the pressure of the fluid provided from the fluid supply part to the pressure chamber for the output shaft to rotate as one selected from the input side driving gears is connected with the output side driven gear corresponding to the selected input side driving gear and rotates along with the same.

3. The transmission of claim 2, further comprising one direction clutch which is disposed between the input shaft and each input side driving gear and serves to make another input side driving gear rotate idle, said other input side driving gear rotating faster than the selected input side driving gear when one selected from the input side driving gears is engaged with the output side driven gear corresponding to the selected input side driving gear and rotates with the output side driven gear.

4. The transmission of claim 2, further comprising a flow path rod which includes:
a plurality of flow paths communicating with the fluid supply part and the plurality of the divide flow paths for selectively supplying fluid through one divide flow path among the plurality of the divide flow paths; and
a plurality of flow path guide grooves which are formed at the inlet and outlet portions of the flow paths along a circumferential direction on an outer surface,
said flow path rod being connected with the output shaft for one region of the same to be inserted into the pressure chamber.

5. The transmission of claim 1, wherein said reverse rotation intermediate gear is engaged to a gear which serves a backward movement among a plurality of input side driving gears.

6. The transmission of claim 1, wherein a combination of the plurality of the input side driving gears and the plurality of the output side driven gears has one backward moment stage and eighth forward movement speed change stage.

7. The transmission of claim 6, wherein when one speed change stage selected from the forward movement eight stages is undergone by means of hydraulic pressure provided from the hydraulic pump to the pressure chamber in accordance with a control signal of the control part, an input side driving gear and an output side driven gear of a high speed stage region higher than a corresponding speed change stage rotate in a slip friction state, and the input side driving gear and the output side driven gear of the corresponding speed change stage rotate in a stop friction stage, and an input side driving gear and an output side driven gear of a low speed stage region lower than the corresponding speed change stage rotate in a stop friction state, and other input side driving gears, which rotate in the stop friction state and rotate faster than the input side driving gear of the corresponding speed change stage by means of a difference in the circumferential speed between the input side driving gear and the output side driven gear, rotate idle by means of one direction clutch.

8. The transmission of claim 6, wherein said backward movement stage forms a hydraulic flow path independent from the eight forward movement speed change stages.

9. The transmission of claim 1, wherein a thrust bearing is disposed between the input side driving gears.

10. The transmission of claim 4, further comprising:
a flow path rod housing which is engaged to an outer side of the body housing and surrounds and supports the exposed portions of the flow path rod exposed to the outside of the body housing.

11. The transmission of claim 10, wherein a plurality of communication parts communicating with the flow path are formed at the surface of the flow path rod housing, with a nipple being engaged to each communication part.

12. The transmission of claim 11, further comprising:
a plurality of solenoid valves which are provided at a hydraulic supply line extended from the hydraulic pump to the nipple and are turned on and off by means of the control part.

13. The transmission of claim 4, wherein said flow path rod and said output shaft are ether integral types or separated types, and when the flow path rod and the output shaft are the separation types, the flow path rod and the output shaft are engaged by keys.

14. The transmission of claim 2, wherein said plurality of the friction members are arranged at regular intervals along the circumferential direction in the interior of the cam space.

15. The transmission of claim 14, wherein said plurality of the friction members are arc type blocks or balls.

16. The transmission of claim 14, wherein said plurality of the piston are provided corresponding to the plurality of the friction members one by one.

17. The transmission of claim 3, wherein a combination of the plurality of the input side driving gears and the plurality of the output side driven gears has one backward moment stage and eighth forward movement speed change stage.

18. The transmission of claim 17, wherein when one speed change stage selected from the forward movement eight stages is undergone by means of hydraulic pressure provided from the hydraulic pump to the pressure chamber in accordance with a control signal of the control part, an input side driving gear and an output side driven gear of a high speed stage region higher than a corresponding speed change stage rotate in a slip friction state, and the input side driving gear and the output side driven gear of the corresponding speed change stage rotate in a stop friction stage, and an input side driving gear and an output side driven gear of a low speed stage region lower than the corresponding speed change stage rotate in a stop friction state, and other input side driving gears, which rotate in the stop friction state and rotate faster than the input side driving gear of the corresponding speed change stage by means of a difference in the circumferential speed between the input side driving gear and the output side driven gear, rotate idle by means of one direction clutch.

19. The transmission of claim 17, wherein said backward movement stage forms a hydraulic flow path independent from the eight forward movement speed change stages.
